(19) United States
(12) Patent Application Publication
(10) Pub. No.: US 2006/0161449 A1
(43) Pub. Date: Jul. 20, 2006

(54) Automated real estate data replication

(76) Inventor: Sam Alexander McKinney, Santa Barbara, CA (US)

Correspondence Address: SAM McKINNEY, 2321 STATE ST., SANTA BARBARA, CA, 93105, US

(21) Appl. No.: 11/331,644

(22) Filed: Jan. 14, 2006

Related U.S. Application Data
(60) Provisional application No. 60/644,422, filed on Jan. 15, 2005.

(51) Int. Cl. G06Q 99/00

(52) U.S. Cl. 705/1

(57) ABSTRACT

A method of replicating real estate data includes automating synchronization of datastores and validating permissions and membership. The method also includes access methods on the device party to replication allowing access to data when computer networks are of insufficient availability or bandwidth.

This application claims priority to and incorporates by reference Provisional Patent Application No. 60/644,422 entitled “Automated Real Estate Data Replication” filed Jan. 15, 2005.

### TECHNICAL FIELD

This disclosure relates to transferring information over a computer network and, in particular, to a method for transferring real estate data over computer networks.

### BACKGROUND

Real estate data is often accessible by computer. Users often access this data over computer networks. It is generally important to restrict access to portions of this data available on these networks. Real estate data is often large due to an abundance of listings and multi-media content. Users may have relatively high-speed access to these computer networks for portions of their time and low, intermittent, or no access during other portions of their time. There is a need for a better method of access to address market demand.

It is commonplace to find real estate data stored for access by computer. As an example, a multiple listing service (“MLS”) often stores real estate data such that it is accessible by computer. Other real estate information may be found in personal data or internet-based businesses that use real estate data as content, and other applications. Often, to interact with real estate data, information needs to be transmitted over a computer network. For instance, MLS data is frequently accessed from a centralized location through MODEM, LAN, and internet computer networks. Similarly, internet-based providers of real estate data provide access over computer networks.

It is often necessary to enforce access limitations on real estate data. Particular users may only be able to access a subset of data based on geographic regions, MLS association membership, payment of dues, or other factors. This can cause an administrative load when manual steps play a role in the authentication and verification process. In the market today, many solutions rely on such manual steps. This has led to reduced adoption rates and high operational costs for these systems.

Real estate data can be very large. For instance, a typical MLS may contain thousands of entries and each entry may include multi-media content such as images or map data. State or Nation-wide aggregate data providers can see data sizes of several orders of magnitude larger than a typical MLS. Therefore, it is generally practical to access real estate data over a computer network only when the network is of sufficient speed and bandwidth.

Most businesses and increasingly many homes are now equipped with a suitable computer network to access centralized real estate data. However, in many cases, access to real estate data is desired when a computer network is not available or is limited in speed or bandwidth. This is often the case with real estate professionals who can spend large amounts of time out of the office. This is particularly the case when they are touring properties with their clients. In these circumstances, the only available network connectivity may be through wireless networks which may provide limited connectivity or be completely unavailable. While these drawbacks may not have consequences in some instances, scenarios can be imagined in which such effects are dire. For example, a real estate professional may miss an opportunity to engage a sale if timely real estate information is not available due to poor network connectivity.

This fragile dependency on computer networks is a serious drawback to the current solutions for real estate data access. This is evident from analyzing prior art approaches such as U.S. Pat. No. 6,484,176. This process addresses the need for accessing real estate data using a portable computing device, but requires a computer network between the portable device and database server to effect a search interaction. When such a computer network is unavailable, there is no ability to perform new search interactions to completion.

Therefore, there is a need for accessing real estate data when, from time-to-time, a computer network is not available or when computer network access is degraded or intermittent. Preferably, the solution to this need will allow for minimal requirements on the operator.

### SUMMARY OF THE INVENTION

In one implementation, a method for accessing real estate data includes replicating networked real estate data to a local computer. The local computer includes methods to access and display the real estate information.

One or more of the following features may also be included: The method also includes facilitating this data replication through one or more 3^{rd} party computers on one or more computer networks. The method also includes a plurality of access methods to allow the local computer to access remote real estate data when a computer network is available and sufficient and to access local real estate data when a computer network is unavailable or insufficient. The method also includes a process for replication that reduces bandwidth usage. The method also includes a process for verifying user access permissions and membership. The method also includes a process for replication that is autonomous such that it requires no user interaction.

In another implementation, the local computer may be a portable computing device. In another implementation, the local computer may be a hybrid device supporting general-purpose computation and other functionality such as a cellular phone. In yet another implementation, the local computer may be an application-specific device configured for a specific purpose of accessing real estate data.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a block diagram depicting a network of server, 3^{rd} party, and local computation devices and their respective datastores.

FIG. 2 is a flowchart that represents a data access request on a local computation device.

FIG. 3 is a flowchart that depicts a process for automating real estate data replication.

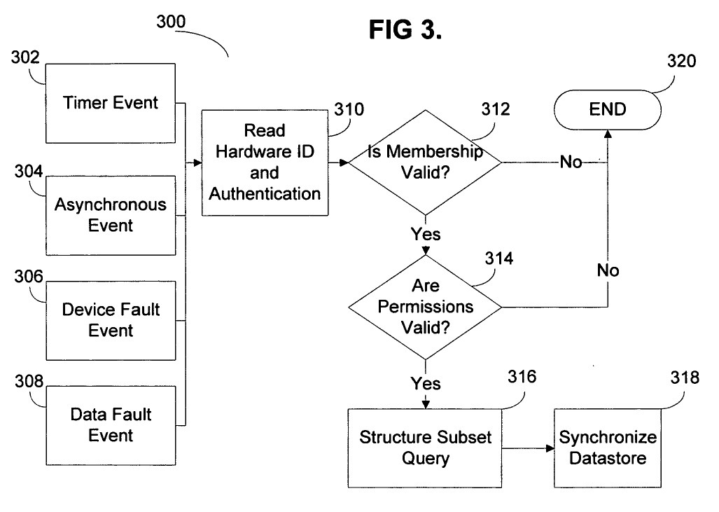

FIG. 4 is an exemplary SQL listing describing a schema for a datastore containing real estate data listings.

FIG. 5 is an exemplary SQL listing describing a schema for a datastore containing real estate access users.

### DETAILED DESCRIPTION OF THE PREFERRED EMBODIMENTS

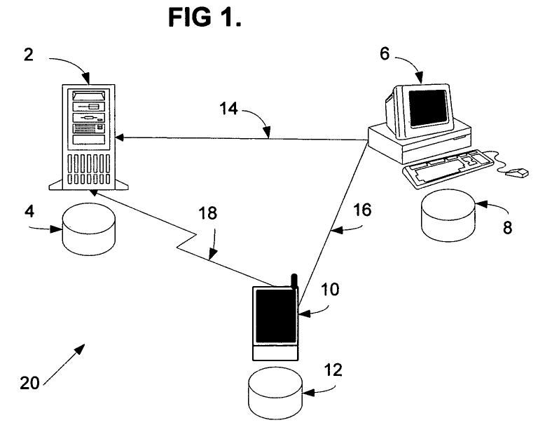

Find depicted in FIG. 1 a system 20 for remotely replicating real estate data over a computer network. A server 2 may be one or more network accessible computers that provide access to real estate data. Such data and their access methods, hereafter “datastore,” may be organized in a relational database and exposed to the network for access through SQL queries. The datastore format may be any structured storage format including text metadata markup or flat-file representations. The datastore access methods may be any structured data access method including remote method invocation or custom network layer protocols. The datastore 4 is accessible by server 2 and may exist on internal storage media. The datastore may also exist on external storage media, as an in-memory image, or any method that provides access to the data from the indicated computation device.

A computer network 18 is shown to connect server 2 and local computational device 10. Such a connection may be created at times by a wired internet connection or at other times by a wireless internet connection. The network connection 18 represents one connection between server 2 and local computation device 10; however, many connections may exist between 2 and 10 or between 2, 10, and other computers through this or another computer network. The network connection may be bi-directional or unidirectional with data “pushed” from server 2 to local computation device 10. Computer network 18 represents one possible transport option for initiating a replication transaction between server 2 and local computation device 10.

The local computation device 10 has an operatively connected datastore 12. The network connection 18 may be used to perform real estate datastore replication by “real state data sync.” This method is described in detail below.

A computer network 14 is shown to connect server 2 and 3^{rd} party computer 6. Such a connection may be created by a wired internet connection. The network may also be created through other wired and wireless networking methods. The network 14 represents one connection between server 2 and 3^{rd} party computer 6; however, many connections may exist between 2 and 6 or between 2, 6, and other computers through this or another computer network. The network connection may be bi-directional or unidirectional with data “pushed” from server 2 to 3^{rd} party computer 6.

The 3^{rd} party computer 6 is operatively connected to datastore 8. The datastore may be a full or partial replication of the datastore 4. This may occur through “real estate data sync.” A computer network 16 is shown to connect 3^{rd} party computer 6 to local computation device 10. The 3^{rd} party computer may act as a relay or proxy for server 2 allowing local computation device 10 to perform “real estate data sync” when local computation device 10 is connected to network 16 and network 18 may or may not be available. The 3^{rd} party computer may also provide access to its datastore 8 for “real estate data sync” with local computation device 10. This computer may be a user terminal whereby real estate data may be accessed.

The server 2, local computation device 10, and 3^{rd} party computer 6 are depicted as a server computer, handheld computer, and workstation computer respectively, but each device may be a server, a workstation, cellular phone, portable computing device or any electronics with sufficient general purpose computation capacity to provide the data access service responsibilities assigned to each component. The server 2, datastore 4, 3^{rd} party computer 6, datastore 8, local computation device 10, datastore 12, network connection 14, network connection 16, and network connection 18 are depicted as physical computation devices and computer networks; however, one or more of these computers may run as virtual processes and communicate through virtual network connections within a single device.

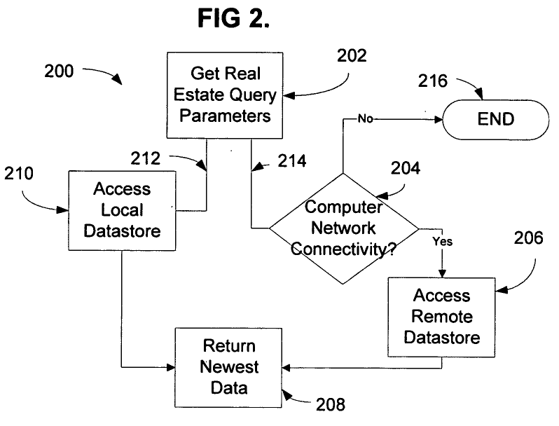

Referring to FIG. 2, a flowchart 200 represents tasks executed by a computation device (e.g. local computation device 10) when real estate data access is requested. A real estate access request is initiated after real estate query parameters are available 202. In one implementation, only path 212 is present and the computation device subsequently accesses its local datastore 210 to produce results. Since data access occurs only on the device 10 there is a mode of operation that is completely operational when computer networks 18, 16 or 14 are unavailable. Moreover, datastore 10 may be physically stored on media that is of sufficient size to allow queries to return complete results without the use of networks 18, 16 or 14.

In another mode of operation, from state 202, the computation device initiates two threads to simultaneously follow paths 212 and 214. The path traversed along 212 remains the same; however, a number of tasks are simultaneously executed along path 214. The computer network (e.g. computer network 16 or 18) connectivity is evaluated for existence and sufficiency of bandwidth by evaluating PING timing, latency measures or other methods. If it is determined that the network is not sufficient or is unavailable, this parallel process terminates at final state 216. If it is determined that a computer network is available and sufficient, an access request is made to server 2 or 3^{rd} party computer 6. The result of this access is then used by state 208 which examines the local and remotely returned data. If the remote data was returned

A flowchart defines possible modes of operation. In local mode, all queries are answered locally. In remote mode, all queries are answered remotely. In hybrid mode, all queries are answered first remotely, then locally in failover.

A client (note these could be reversed). The server has a real estate information database. The client maintains a real estate information database. (Client or server can be portable, mobile, handheld, cellular computational devices. Network can be wired, wireless, etc. The real estate information can be stored in RAM, ROM, local disk storage, external disk storage, memory card, networked storage, etc.) Real estate information database may contain current listings, old listings, other types of data such as assessor information, parcel data, tax information, loan rates, association members, etc. Local computer and Server may actually be running on the same machine.

A flowchart defines synchronization. A query defines the data subset for the user. All of this data is replicated to the local database. A subset could be replicated to if desired. A user's credentials are stored in the local computer and sent to the remote computer. Synchronization occurs via timer or external stimuli. Results may be timestamped to indicate to user what the last update was—and that data is only relevant to that point. Automating the replication of real estate data requires the automation of several components including:

Depicts an automated process for initiating a replication event. A process for selecting a subset of data configured to be relevant for a particular device context. A process for pushing data to the device or a trigger to the device to initiate a poll event via transport such SMS. If the database is detected as being corrupt, it deletes the database and downloads the fresh one. If the application is stored in-memory and a power fault occurs, an automated process for restoring the in-memory representation from a permanent store or network storage.

A process for in-memory replacement of the operating instructions to replace application code with newer versions. An automated process for ensuring membership and payment currency for registered device users in the system. Also reference the device ID to ensure the appropriate device.

All of this interaction can occur with endless 3^{rd} party intermediaries. I.E. MicroMLS is between client and REAL server with real estate information database. AND desktop computer is involved in synching handheld.

A number of implementations have been described. Nevertheless, it will be understood that various modifications may be made. Accordingly, other implementations are within the scope of the following claims.

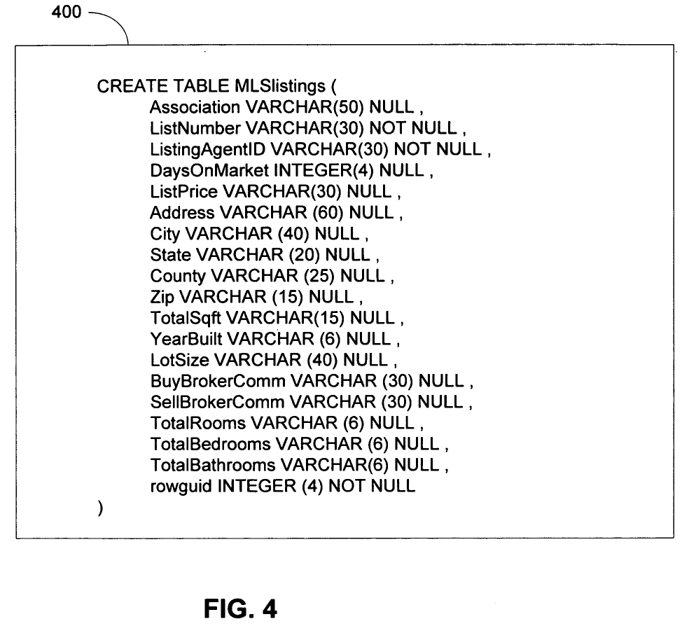

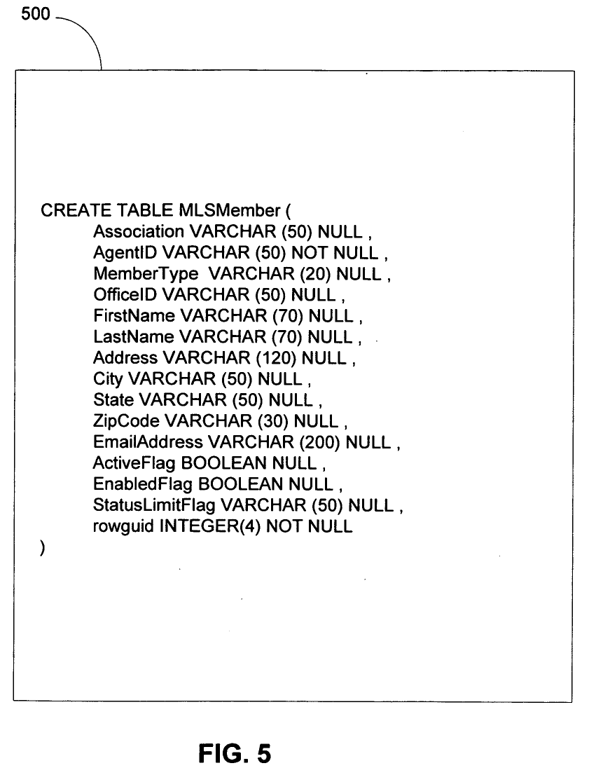

Referring to FIG. 4, an SQL listing 400 is presented that is an exemplary description of datastore fields for storing real estate data. Referring to FIG. 5, an SQL listing 500 is presented that is an exemplary description of datastore fields for storing reale state access data.

What is claimed is:

1. A system for providing access to a real estate information database on a portable computing device, comprising:
a portable computing device having a local real estate information database server with persistent storage of listing records, each listing record having fields describing property characteristics;
a means of database replication with another database server;
a communications link for transport of data;
a local database connector to the remote datastore;
a means of determining the newest data record;

2. A system according to claim 1, the remote client further comprising a means of verifying valid membership prior to replicating data.

3. A system according to claim 1, wherein data is retrieved locally if network connectivity is not available, or of insufficient speed.

4. A system according to claim 1, wherein the database is a relational database.

5. A system for providing access to a real estate information database on a portable computing device, comprising:
a portable computing device having a local real estate information database server with persistent storage of listing records, each listing record having fields describing property characteristics;
a means of database replication with another database server;
a communications link for transport of data used in replication;
a means of autonomously initiating replication;

6. A system according to claim 5, the remote client further comprising a means of verifying valid membership prior to replicating data.

7. A system according to claim 5, wherein data is retrieved locally if network connectivity is not available, or of insufficient speed.

8. A system according to claim 5, wherein the database is a relational database.

9. A system according to claim 5, wherein the database replication is manually initiated.

10. A system according to claim 5, wherein the database replication is autonomously initiated at fixed intervals.

11. A system for providing access to a real estate information database on a desktop or laptop computing device, comprising:
a computing device having a local real estate information database server with persistent storage of listing records, each listing record having fields describing property characteristics;
a means of database replication with another database server;
a communications link for transport of data used in replication;
a means of autonomously initiating replication;

12. A system according to claim 11, the remote client further comprising a means of verifying valid membership prior to replicating data.

13. A system according to claim 11, wherein data is retrieved locally if network connectivity is not available, or of insufficient speed.

14. A system according to claim 11, wherein the database is a relational database.

15. A system according to claim 11, wherein the database replication is manually initiated.

16. A system according to claim 11, wherein the database replication is autonomously initiated at fixed intervals.
